(19) United States
(12) Patent Application Publication
(10) Pub. No.: US 2005/0011745 A1
(43) Pub. Date: Jan. 20, 2005

(54) Hybrid electrical discharge reactors and the use of zeolites to enhance the degradation of contaminants

(76) Inventors: Bruce R. Locke, Tallahassee, FL (US); Austin Appleton, West Point, NY (US); Pavel Sunka, Prague (CZ); Natalija Koprivanac, Zagreb (HR); Hrvoje Kusic, Samobor (HR)

Correspondence Address: AKERMAN SENTERFITT, P.O. BOX 3188, WEST PALM BEACH, FL, 33402-3188, US

(21) Appl. No.: 10/620,007

(22) Filed: Jul. 15, 2003

(51) Int. Cl. H05F 3/00; B01J 19/08

(52) U.S. Cl. 204/164; 422/186.04

(57) ABSTRACT

A multi-phase hybrid reactor provides simultaneous gas and liquid phase high voltage electrical discharges that provide highly reactive species that destroy contaminants as in both gas and liquid phase. Catalytic particles, including various types of zeolites, can further enhance the rate of contaminant degradation.

### FIELD OF THE INVENTION

The invention relates to systems and methods for the destruction of contaminants using electrical discharge reactors, specifically hybrid discharge reactors which utilize both electrical discharges in both the gas and liquid phases.

### BACKGROUND

In recent decades, environmental focus on contaminated wastewater, groundwater, gases from soil, or automotive exhaust is increasing. In some cases, a great deal of effort is spent cleaning up contaminated sites. More restrictive discharge limits and increasing permit requirements established under the Clean Water Act are increasing the cost of waste water treatment. With an increased interest relating to environmental cleanup, new and improved technologies must be developed.

One solution for removal of contaminants from the environment involves corona reactors. These reactors are based upon a non-thermal plasma (i.e., a system of highly ionized species which are on average electrically neutral) where the temperature of the free electrons greatly exceeds the temperature of the background species. This type of plasma can be produced, for instance, by a high voltage electrical discharge as well as by electron beams. Non-thermal plasmas have the advantage that the electrical energy of the discharge is directed primarily into increasing the motion of the electrons rather than to heating the background species. These highly energetic electrons can be used for a number of purposes, such as initiating desirable chemical reactions in bulk gases or liquids, or on the surfaces of solids.

Corona discharge reactors have the potential to be utilized for numerous commercial applications. For example, gas phase discharges can be used to reduce or oxidize, depending upon the chemical environment, hazardous and toxic gases such as nitrogen oxides and sulfur dioxide. Gas phase electrical discharges have also been used commercially for the production of ozone for many years. Liquid phase discharges have recently been used to oxidize small aromatic organic species. Surface discharges are commercially used for the plasma coating of polymers. Pulsed corona reactors have been shown to effectively degrade a wide variety of contaminants.

Liquid phase corona reactors have been used extensively and developed for the degradation of pollutants in an aqueous environment. The liquid phase corona reactor utilizes a high voltage pulsed electric discharge in the liquid phase to generate chemically reactive radicals, ions, and molecular species in solution that in turn lead to the partial or complete degradation or conversion of pollutants to less harmful byproducts. Pulsed streamer corona discharges create streamer channels that propagate in solution from one electrode to another and are limited in diameter and length.

Gas phase pulsed corona reactors have also been used and utilize a high voltage pulsed electrical discharge in the gas phase to generate chemically reactive species in the gas phase to treat contaminants in either the gas or liquid phase of the reactor. In an oxygen rich atmosphere, the primary species formed directly by the discharge is ozone from reactions between oxygen molecules and free electrons. In a humid atmosphere, hydrogen peroxide, hydroxyl radicals, and free electrons are also formed. In most cases, a high voltage electrode is suspended in the gas phase while the ground electrode is submerged in the liquid phase. The products then dissolve into the aqueous phase. This process tends to work well with aqueous contaminants susceptible to degradation by direct reactions with ozone.

### SUMMARY

In one embodiment of the invention, reactors having a novel electrode configuration generate electrical discharges in both the gas and liquid phases and create chemically active species in both the gas and liquid phases of the reactor. These reactors are referred to herein as hybrid reactors as they utilize gas and liquid phase discharges. A hybrid-parallel reactor is one embodiment of a hybrid reactor and comprises three electrodes: a first electrode in solution, a second electrode in the gas phase, and a central electrode located between the first and second electrodes, such as near the gas-liquid interface. A power supply generates a pulsed electrical discharge between the first and central electrodes and also between the central and second electrodes. The hybrid-parallel reactor provides highly uniform plasma in the radial cross-section of the reactor and allows for scale-up of the reactor to large diameter systems. The reactor can include catalysts such as zeolites, platinum, and photocatalysts to enhance the rate of degradation of contaminants. Catalysts described herein can generally be disposed in either the gas or liquid phase. Chemically reactive liquid phase species generated can include hydrogen peroxide, hydrogen and hydroxyl radicals. Chemically reactive gas phase species generated can include ozone, oxygen radicals, hydroxyl radicals and gaseous ions.

In another embodiment of the invention, catalytic particles, including various types of zeolites and photocatalysts, are used with hybrid reactors to enhance the removal rate of contaminants. This embodiment of the invention can be practiced with a hybrid-parallel reactor as defined above, or a hybrid-series reactor. A hybrid-series reactor includes two electrodes, a first electrode in solution and a second electrode in the gas phase. A power supply generates a high voltage pulsed electrical discharge between the two electrodes resulting in the formation of chemically reactive species in both the gas and liquid phases.

Additionally, the invention features a method for destruction of contaminants including the steps of generating high voltage pulsed electrical discharges in both the gas and liquid phase to produce chemically active liquid phase and gas phase species to degrade contaminants in the liquid or gas phase. This invention can be used for water treatment or to treat contaminants in the gas phase or on the surface of solids.

### BRIEF DESCRIPTION OF THE DRAWINGS

A fuller understanding of the present invention and the features and benefits thereof will be accomplished upon review of the following detailed description together with the accompanying drawings, in which:

FIG. 1 illustrates a hybrid-parallel reactor which generates simultaneous high voltage electrical discharges in both the liquid and gas phases, according to the embodiment of the invention.

FIG. 2 illustrates a hybrid-series reactor which includes an electrode in the liquid phase and another electrode in the gas phase, according to the embodiment of the invention.

FIG. 3 is a graph showing hydrogen peroxide formation as a function of time for both the single-phase aqueous (reference reactor) and hybrid-parallel reactors.

FIG. 4 is a graph showing nitrobenzene degradation as a function of time for both the single-phase aqueous (reference reactor) and hybrid-parallel reactors.

FIG. 5 is a graph displaying the effects of zeolite catalysts in the removal of dye when zeolite is used in the liquid phase of the hybrid-parallel reactor.

FIG. 6 is a graph displaying the effects of zeolite catalysts in the removal of phenol when zeolite is used in the liquid phase of the hybrid-parallel reactor.

FIG. 7 is a graph displaying the effects of zeolite catalysts in the removal of phenol when zeolite is used in the liquid phase of the hybrid-series reactor.

### DETAILED DESCRIPTION

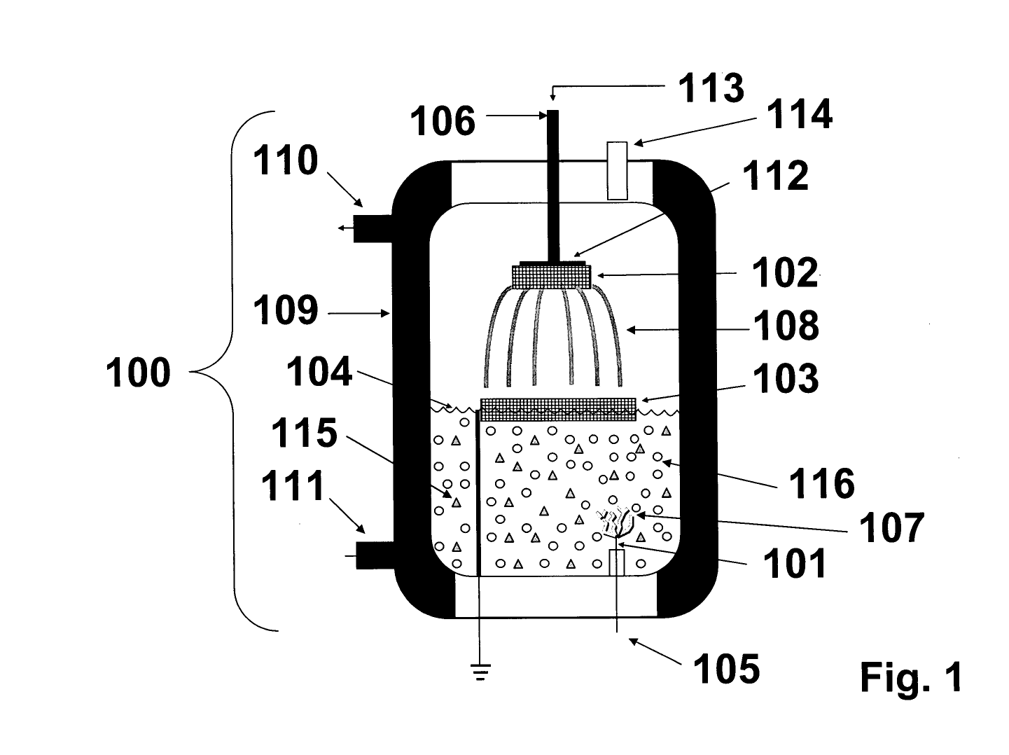

The invention provides systems and methods for the destruction of contaminants in the gas and/or liquid phase, and/or on the surfaces of solids. In one embodiment of the invention, a multi-phase hybrid pulsed corona reactor, referred to herein as a hybrid-parallel reactor, includes three electrodes to simultaneously generate high voltage electrical discharges in both the liquid and gas phases of the reactor. A hybrid-parallel reactor 100 according to the invention is shown in FIG. 1. In operation, a high voltage electrical discharge across both the liquid and gas phases produces chemically reactive gaseous and liquid species which can degrade contaminants. Reactor 100 as well as the method described herein allow for the increased formation of ozone which can degrade contaminants. Additionally, zeolites can be provided in the liquid phase to enhance the removal rate of contaminants.

### Hybrid-Parallel Reactor

A hybrid-parallel reactor 100 shown in FIG. 1 includes three electrodes, 101, 102 and 103. Electrode 101 is disposed in the liquid phase and is referred to herein as a high voltage electrode 101. Electrode 102 is disposed in the gas phase and is referred to herein as high voltage electrode 102. Electrode 103 is disposed between high voltage electrodes 101 and 102, and is referred herein as central ground electrode 103. The central ground electrode 103 is preferably located at or near the gas-liquid interface 104.

High voltage electrode 101 is shown having a very sharp tip. In solutions, such as water-based solutions, in order to produce an electric discharge, it is necessary to use very sharp electrode needles with the lower part of the needle insulated (not shown) so that the electric field generated is concentrated and very high in a local region surrounding the electrode tip. This is generally required because it takes a very high electric field to create a discharge in solution. To minimize current losses through the stem of the needle, the stem of the needle is preferably electrically insulated.

Although high voltage electrode 102 should generate a concentrated electrical field for efficient reactor 100 operation, since high voltage electrode 102 is disposed in the gas phase it is less sensitive to field spreading as compared to high voltage electrode 101. However, sharp points (although not strictly necessary in DC or non-pulsed discharges) are still generally required in pulsed discharges to produce an effective discharge, although the lower part of the point generally does not need to be surrounded by an insulator.

Ground electrode 103 is shown having a large area. A large area electrode for ground electrode 103 is possible because the electrical field concentration considerations described relative to high voltage electrodes 101 and 102 do not apply to ground electrode 103.

The distance between the high voltage electrode in the liquid 101 and the ground electrode 103 at the gas-liquid interface can vary from approximately 1 cm to approximately 5 cm. The distance between the gas phase electrode 102 and the ground electrode 103 at the gas-liquid interface 104 can vary from less than approximately 1 cm to over approximately 5 cm. The liquid and gas phase high voltage electrodes 101 and 102 can be located anywhere in the liquid or gaseous volume, respectively, providing electrodes 101 and 102 are able to produce high voltage electrical discharges. In a preferred embodiment of the invention, electrode 102 is placed 5 cm above electrode 103.

As noted above, the central ground electrode 103 is preferably located at or near the gas-liquid interface 104. As used herein, “near” the gas-liquid interface 104 refers the maximum distance in which ground electrode 103 can be moved without significantly degrading the performance of reactor 100. Reactor 100 is generally not highly sensitive to the distance of the ground electrode 102 from the liquid-gas interface 104, although best reactor 100 performance generally results when the ground electrode 103 is placed right at the interface 104 as shown in FIG. 1.

Some indirect evidence compiled indicates that placing the ground electrode 102 exactly at the interface 104 may lead to slightly different chemical reactions as compared to when it is displaced from this location 104. When nitrobenzene was degraded using reactor 100 there was some evidence of wear or pitting which suggests surface reactions on the ground electrode 103 when placed so that part of the ground electrode 103 was exposed to the gas phase. There is expected to be an asymmetry in reactor performance as a function of distance from interface 104 because a given distance into the solution is expected to produce a different system 100 performance as compared to the same distance into the gas phase. For example, moving the ground electrode 103 from the interface 104 deeper into the liquid will require that the current from the gas phase high voltage electrode 102 to flow through the liquid to the ground electrode 103.

The liquid phase high voltage electrode 101 can be a metal, for example stainless steel or platinum, or metal alloy wire such as nickel chromium wire. The central ground electrode 103 as well as electrode 102 are preferably composed of a highly electrically conductive material. This material can include but is not limited to reticulated vitreous carbon (RVC). RVC is preferred for the composition of electrodes 102 and 103 due to its high surface area and excellent electrical conductivity. Additionally, electrodes 102 and 103 can be RVC or similar materials coated with metals such as platinum, palladium, rhodium.

It is also possible to form electrodes 101 and 102 using metal plates coated with ceramic or other electrical insulating materials in such a manner that there are very small (<approximately 100 micron) holes through the ceramic so that only a small part of the metal electrode is exposed to the water. This also serves to create a region of high electric field on the electrode and leads to the formation of many small discharges in the water in contrast to the single discharge from a single needle. Thus, electrodes, including the liquid phase high voltage electrode 101 need not be restricted to needles, but could include any material, such as the ceramic coated metal electrodes, that can form discharges in water.

With the materials and geometries described above for reactor 100, it is generally not possible to produce an electric discharge simply using an alternate bias arrangement, such as biasing electrode 103 as high voltage electrode with electrodes 101 and 102 being ground electrodes because of the use of a large area RVC electrode for ground electrode 103. As noted above, to produce an electric discharge, it is necessary to use very sharp electrode needles so that the electric field is concentrated and very high in a local region surrounding the electrode tip.

However, if electrode 103 is embodied as an electrode which provides field concentration (e.g. sharp needle or metal coated with electrical insulator having holes in the insulator) and electrodes 101 and 102 are modified to provide a large area, it may be possible to operate reactor 100 using electrode 103 as a high voltage electrode. In another embodiment, RVC can be coated with an electrically insulating material leaving very small points available for discharge for use as a high voltage electrode. Placing the high voltage electrode in such a case near the water interface with a ground electrode in the gas phase will lead to a series type discharge in combination with a liquid discharge, thus producing different results as compared to reactor 100.

The electrical discharges used with the invention are preferably pulsed electrical discharges. High voltage discharges in the liquid and gas phases result in the formation of chemically reactive species in both of these phases. These species include, but are not limited to, hydrogen peroxide, hydroxyl radicals, ozone, oxygen radicals, hydrogen gas, hydrogen radicals, and hydroperoxyl radicals. Aqueous phase high voltage discharges can result in the formation of hydrogen peroxide, hydroxyl radicals, molecular hydrogen, molecular oxygen, hydrogen and oxygen radicals, and other molecular, ionic, and radical species. High voltage discharges in the gas phase can produce ozone, oxygen radicals, hydroxyl radicals, and other molecular, ionic, and radical species. As a result of increased ozone, hydrogen peroxide, and hydroxyl and other radical formation, the rate of degradation of contaminants is increased through direct ozone attack or reactions with radicals.

In a preferred embodiment, the liquid and gas phase high voltage inputs 105 and 106 are connected to a power supply (not shown) and transmit high voltage electrical signals to electrodes 101 and 102, respectively. The power supply (not shown) can be a rotating spark gap high voltage pulsed power supply. The spark gap power supply can provide pulsed high voltage, short duration pulses, fast rise time and repetitive electrical pulses. High voltage discharges are generated simultaneously between electrodes 101 and 103 in the liquid phase resulting in the formation of streamers 107 as well as gas phase discharges 108 between electrodes 102 and 103.

Optional zeolite particles 115 and photocatalyst particles 116 are shown disposed in solution. The UV light generated by the corona discharge is generally sufficient for activating the photocatalyst particles 116. The concentration of catalysts can vary significantly, however, in a preferred embodiment the concentration of zeolites is from approximately 1 to approximately 2 g/l. The particle size should be such that it can be easily suspended in the liquid through mixing by flow. Alternatively, the zeolites or other catalysts can be attached to the electrodes or other surfaces in the reactor. When photocatalyst particles are provided, the light generated by the corona discharge can lead to generation of hole-electrode pairs. Other catalysts that may be useful include platinum particles or platinum coated particles (for example platinum coated activated carbon) that can enhance reactions through hydrogen gas formation in the discharge as well as through possible other species formed in the discharge.

A jacket 109 surrounding the surface of reactor 100 can include a circulating cooling solution. The cooling solution (i.e., water) is preferably pumped out of the jacket through the cooling solution outlet 110 and recirculated back into the jacket 109 through the cooling solution inlet 111 to prevent reactor 100 from overheating. A pump (not shown) is also attached to the liquid phase of reactor 100 and used to recirculate the liquid sample. The sample recirculation line (not shown), recycles the solution containing the contaminants, can be made of plastic such as high density polyethylene.

Gas phase electrode 102 is preferably attached to the surface of reactor 100 by a support base 112. Support base 112 also houses a gas inlet tube 113. In a preferred embodiment of the invention, inlet tube 113 is composed of a ⅜″ stainless steel tube. Before the gas enters reactor 100 through inlet tube 113, the gas can be humidified. Although humidification of the gas reduces the overall ozone concentration, it generally leads to a more stable gas phase discharge. Reactor 100 also includes a gas exhaust port 114 which is connected to an ozone analyzer (not shown). Following the analysis of the outlet gas for ozone, the exhaust is released to the atmosphere. The overall design of reactor 100 allows for an open gas phase while the liquid phase is a closed system.

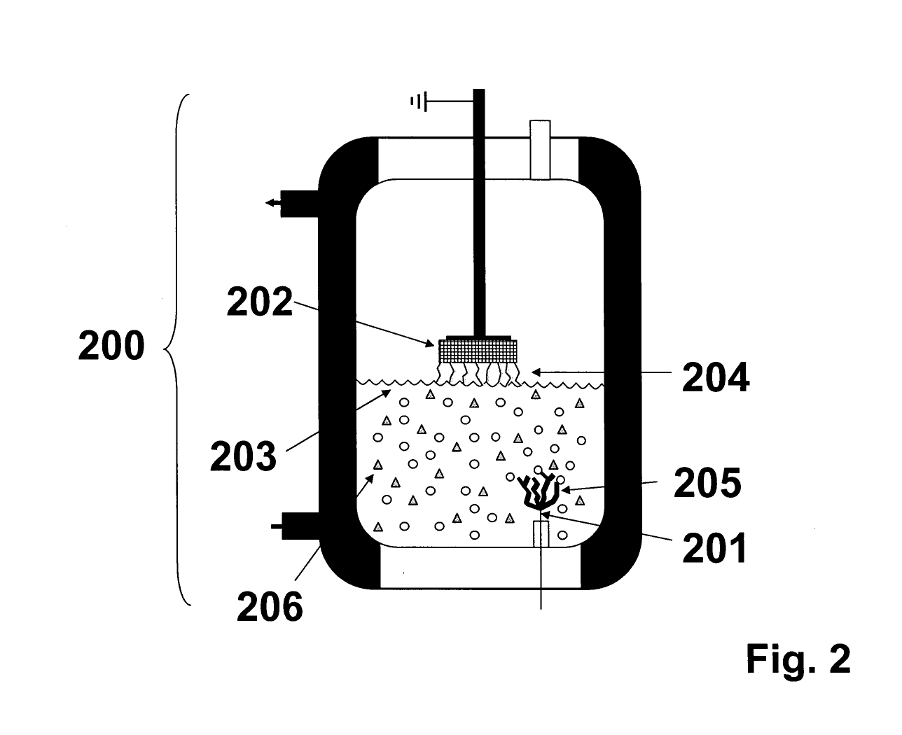

In another embodiment of the invention, a hybrid corona reactor includes a zeolite catalyst in the liquid phase. A hybrid reactor distinct from a hybrid-parallel reactor 100, referred to as a hybrid-series reactor 200 is shown in FIG. 2. Reactor 200 includes two electrodes, a first electrode 201 in the liquid phase and a second electrode 202 in the gas phase suspended above the solution. Application of a high voltage discharge between electrodes 201 and 202 results in gas phase plasma channels 204 and liquid phase streamers 205. The preferred distance of electrode 202 from the gas-liquid interface 203 in reactor 200 is about 5 mm. Other components of reactor 200 are the same as the components described previously for reactor 100. Zeolite particles 206 in the liquid phase of reactor 200 enhance the destruction of contaminants in reactor 200.

A method for degrading contaminants in the gas or liquid phase, or on the surfaces of solids involves the generation of high voltage electrical discharges, which are preferably pulsed electrical discharges, across both a liquid and gas phase to produce chemically reactive gaseous and liquid species. Chemically reactive species generated preferably include ozone and hydroxyl radicals. These species can be formed simultaneously in the gas and liquid phase, respectively. Other chemically reactive species can be formed such as oxygen radicals. The reaction of the chemically reactive species with the contaminant can be via a decomposition, synthesis, substitution, or metathesis reaction, which renders the contaminant non-hazardous.

The liquid phase is preferably water based. However, any solvent which results in the formation of chemically reactive species following electrical discharge is potentially suitable. To increase the electrical conductivity of the solution, additives such as salts (i.e., KCl) can be included in the liquid phase. The gas phase, although preferably including oxygen and argon, can be any gas which results in the generation of chemically reactive species following electrical discharge. To increase the amount of the ozone and other radicals that are generated in the reactor upon electrical discharge, that are transferred into the liquid phase, the gas can be bubbled through the liquid phase of the reactor.

Although reactors 100 and 200 have been described including optional zeolite and photocatalyst particles, the invention can utilize other catalysts. For example, catalysts which, for example, are capable of facilitating the generation of hydroxyl radicals from hydrogen peroxide produced in the aqueous mediums by the high voltage electrical discharges can be useful. Such catalysts can include but are not limited to the use of transition metals, such as iron (ferrous or ferric), manganese, platinum, copper, cobalt, uranium, rhenium, elemental iron, photocatalysts, such as titanium dioxide, cadmium sulfide, manganese oxide, magnesium oxide, lead oxide and zinc oxide.

The invention can be used to destroy a wide variety of organic contaminants, such as aromatics, including phenol, benzene, nitrobenzene, toluene, ethylbenzene, xylene, anthracene and phenanthracene, halogenated hydrocarbons, such as trichloroethylene, tetrachloroethylene, perchloroethylene and other chlorinated and brominated hydrocarbons, nitrogen-containing compounds, such as nitrobenzene and cyanide, sulfur-containing compounds, such as mercaptans, phosphorous containing compounds, and aliphatic compounds, such as hydrocarbons, alcohols and carboxylic acids, in aqueous solutions, such as waste waters, and organic dyes. Additionally, gas phase pollutants can include nitrogen oxides, sulfur oxides, hydrochloric acid, mercury vapor, freons, Dioxin, chloro-fluorocarbons, and other organic compounds.

Those having ordinary skill in the art will recognize that a plurality of alternate hybrid reactor designs will be possible using the invention. For example, a reactor can be embodied as a combined series/parallel reactor (not shown) where the ground electrode is exclusively in the gas phase above the water and there are two high voltage electrodes, such as one high voltage electrode in water with a needle tip, and one in the gas phase, such as formed from RVC.

### EXAMPLES

The present invention is further illustrated by the following specific examples. The examples are provided for illustration only and are not to be construed as limiting the scope or content of the invention in any way.

### Example 1

### Effectiveness of Hybrid Parallel Corona Reactor in Degrading Nitrobenzene

The hybrid-parallel reactor 100 without optional zeolite 115 or photocatalyst particles 116 was compared to a conventional single phase aqueous reactor (not shown), which is referred to herein as a reference reactor, for effectiveness in degrading nitrobenzene. In both cases, the liquid phase electrode was made of 0.05 mm NiChrom (nickel chromium) wire and the ground electrode was composed of RVC. The gas phase high voltage electrode 102 in the hybrid-parallel reactor 100 was also made of RVC. In the reference reactor, the high voltage electrode was 5.7 cm from the ground electrode whereas the gas phase high voltage electrode disposed in reactor 100 was 5 cm from the ground electrode 103.

A pulsed power supply was utilized for the generation of electrical discharges which produced 45 kV pulses, a pulse repetition rate of 60 Hz, and a pulse energy of 1.1 J/pulse. The same glass reactor was used for both experiments (capacity of ˜1 L). Each reactor was surrounded by a water jacket (maintained at 15° C.) to prevent overheating. The solution for the liquid phase of the reactor included 550 mL KCl (0.9 mmol/L) with an initial solution conductivity of 130 μS/cm. The recirculation line was made of high density polyethylene (HDPE) and connected to a pump (400 mL/min.). The inlet gas stream was composed of 200 mL/min argon and 150 mL/min oxygen. To increase gas humidity (for more stable gas phase discharge), the inlet gas stream was humidified by utilizing a water filled gas wash bottle. Gas phase ozone concentration measurements were conducted using a PCI Ozone Corporation ozone monitor (model HC-1) and results were verified using the iodometric method (i.e., running the reactor outlet stream through a gas wash bottle containing KI solution). The concentration of hydrogen peroxide was determined calorimetrically employing the reaction of hydrogen peroxide with titanyl ions. The concentration of nitrobenzene in solution was analyzed using a Perkin Elmer high performance liquid chromatograph.

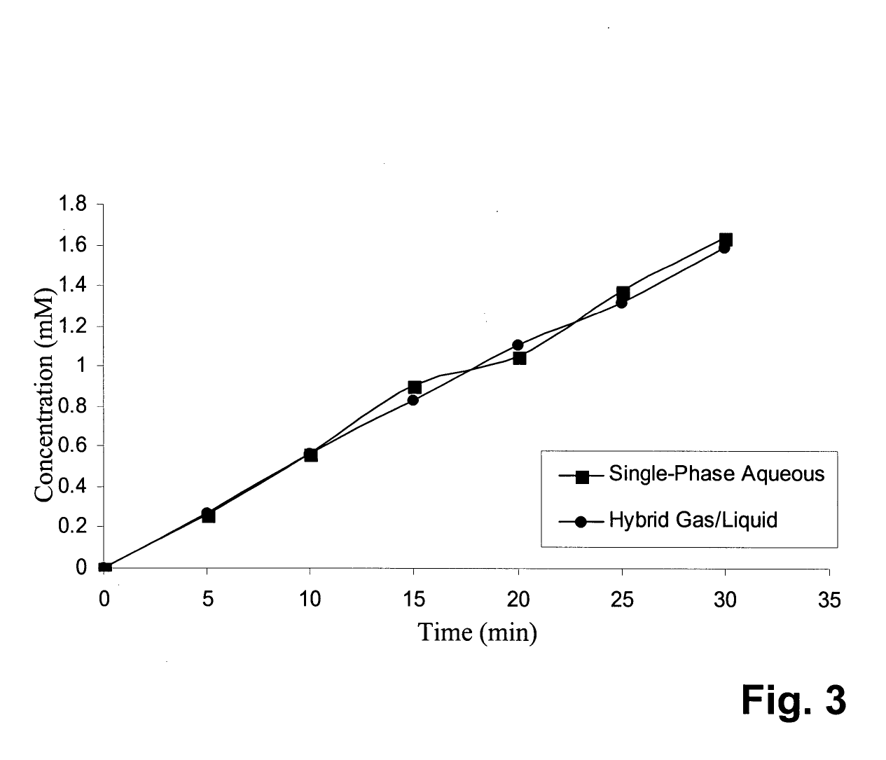

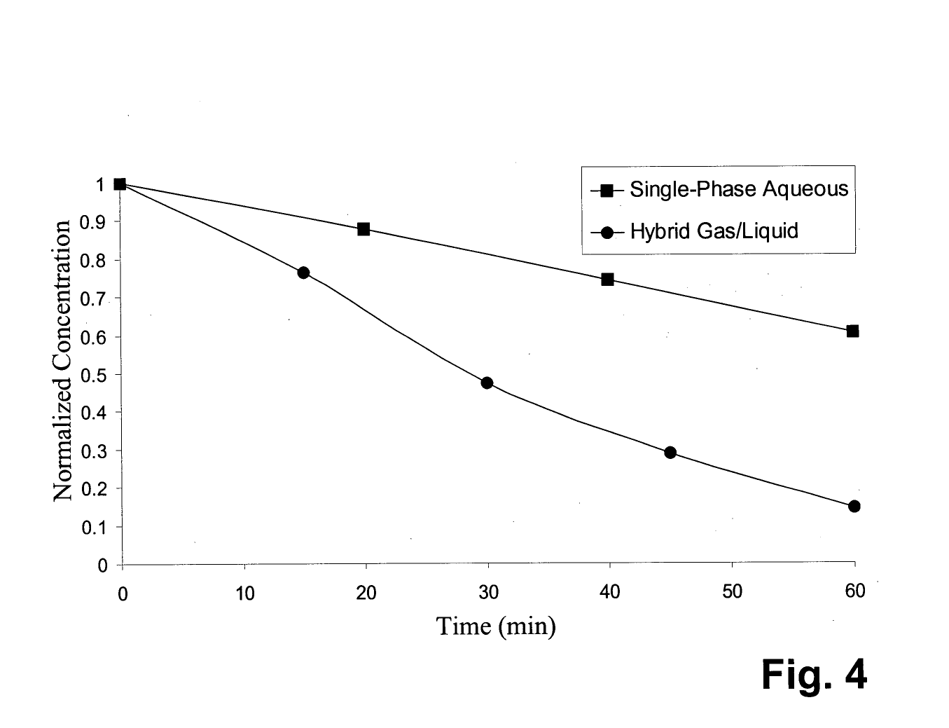

As shown in FIG. 3, both reactor 100 and the reference reactor displayed comparable hydrogen peroxide formation rates. FIG. 4 shows the rate of nitrobenzene degradation. Reactor 100 was more effective in removing nitrobenzene from solution as compared to the reference reactor. Specifically, the nitrobenzene degradation provided by reactor 100 was about two times greater than the reference reactor.

Reactor 100 also showed a substantially higher ozone concentrations as compared to the reference reactor. Since the rate of hydrogen peroxide formation was similar for both reactors and the direct reaction between hydrogen peroxide and nitrobenzene was negligible, the increased rate of nitrobenzene degradation was primarily attributed to the formation of ozone and/or other reactive species including but not limited to hydroxyl and oxygen radicals, in the gas phase, their dissolution into the aqueous phase, and subsequent reactions with other chemically active species. Thus, enhanced ozone and other gas phase reactive species production were believed to produce an increased degradation rate for nitrobenzene.

### Example 2

### Zeolites for Enhanced Degradation of Contaminants in Hybrid Corona Reactors

The effect of zeolites were formulated for both reactor 100 and reactor 200. Optional photocatalyst particles 116 were not used.

Five milliliters of 0.1 M KCl was added to the aqueous solution (for use as the liquid phase in the reactor) and the pH adjusted with HCl or NaOH (from approximately 3 to approximately 6). The initial conductivity of the solution, voltage applied, and gas flow rates were the same as described in Example 1. The temperature of the solution was 20° C. After the addition of 1 g/L of the desired zeolite, a high voltage pulsed corona was applied for 60 min. Three samples were taken from the solution every 10-15 minutes (for reproducibility) and the zeolites removed by centrifugation. The desired contaminant was analyzed spectroscopically. For example, phenol (100 ppm initial concentration) was analyzed using HPLC whereas dye was measured using a UV spectrophotometer.

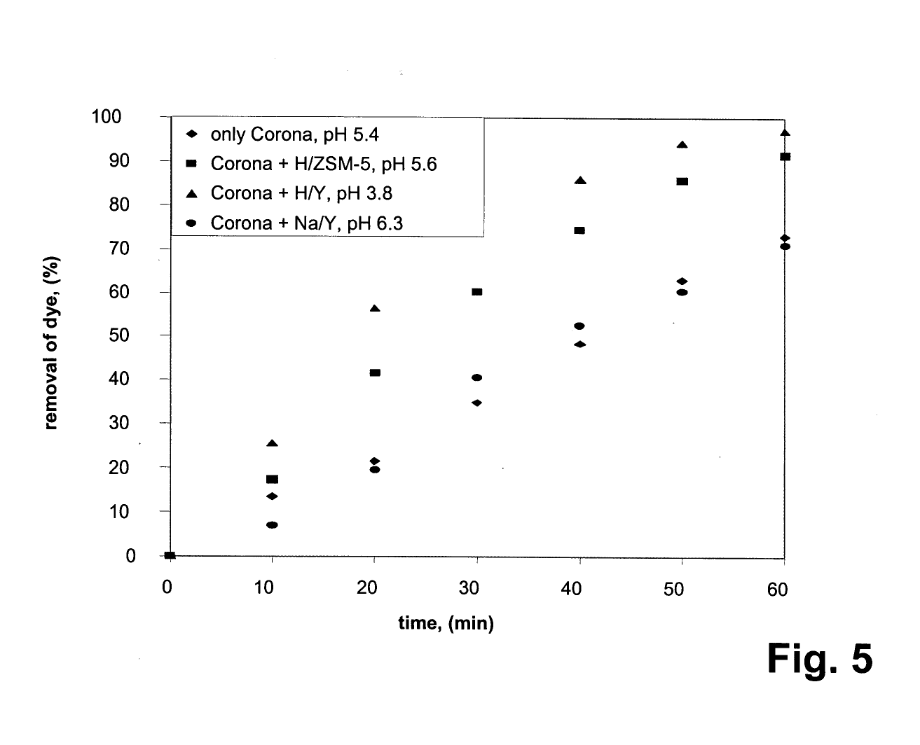

Zeolite catalysts were found to enhance the destruction rate of contaminants using reactor 100. FIG. 5 shows the effect of the addition of three different zeolite catalysts to the liquid phase of reactor 100 for removal of a dye (reactive blue 137). Compared to the efficiency of reactor 100 without zeolites, two zeolites (H/Y and H/ZSM-5) were found to significantly enhance the rate of dye degradation by reactor 100.

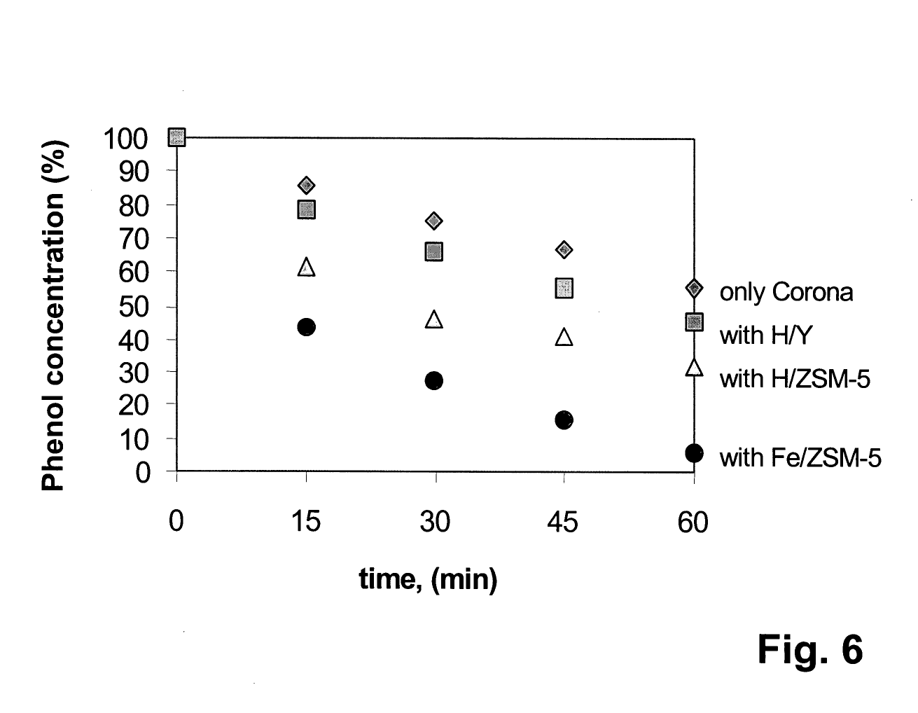

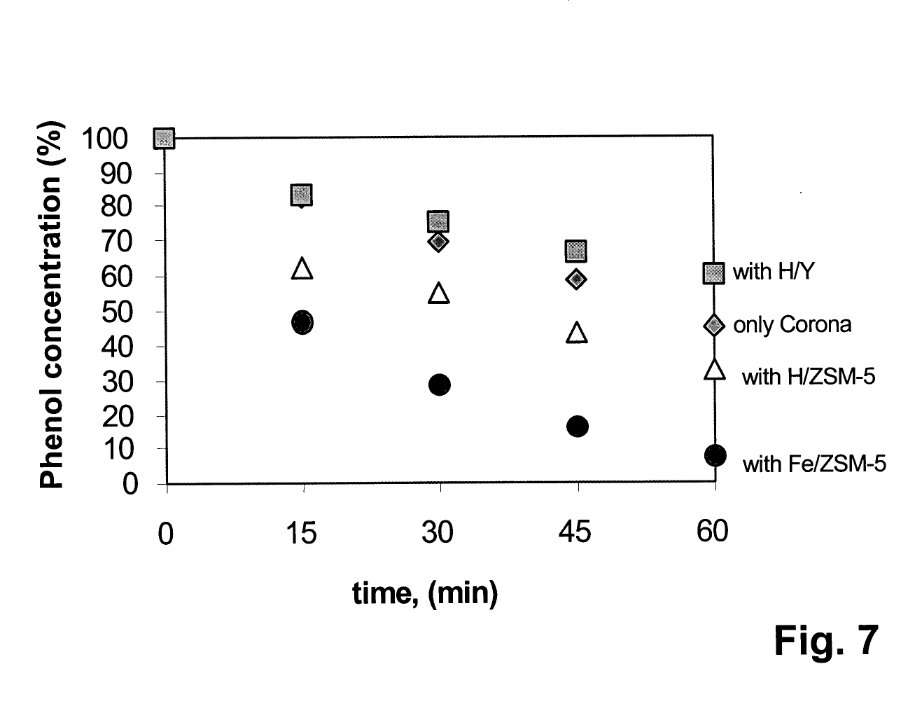

Additionally, as displayed in FIG. 6, the zeolites H/Y, H/ZSM-5, and Fe/ZSM-5 were examined for their effect on the degradation of phenol. All of the zeolites tested enhanced the rate of destruction of phenol. In addition to the effects of zeolites with the hybrid-parallel reactor 110, the effects were also evaluated on hybrid-series reactor 200. As shown in FIG. 7, the hybrid-series reactor displayed greater efficiency in the destruction of phenol using zeolites H/ZSM-5 and Fe/ZSM-5.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A reactor, comprising:
at least a first electrode disposed in a liquid volume;
at least a second electrode disposed in a gaseous volume above said liquid volume;
at least one central electrode disposed between said first and said second electrode, said gaseous volume having an interface with said liquid volume; and
at least one power supply connected to said electrodes for generating an electrical discharge between said first and central electrodes and an electrical discharge between said central and second electrodes.

2. The reactor of claim 1, wherein said central electrode is disposed at or near an interface between said gaseous and said liquid volume.

3. The reactor of claim 1, wherein at least one of said electrical discharges comprises pulsed electrical discharges.

4. The reactor of claim 1, wherein chemically reactive liquid phase species generated by said reactor comprise at least one of hydrogen peroxide, hydrogen, and hydroxyl radicals.

5. The reactor of claim 1, wherein chemically reactive gas phase species generated by said reactor comprise at least one of ozone, oxygen radicals, hydroxyl radicals, and gaseous ions.

6. The reactor of claim 1, wherein said liquid or gaseous volume includes at least one catalyst.

7. The reactor of claim 6, wherein said catalyst includes zeolite, wherein said zeolite is disposed in at least one of said liquid volume and said gaseous volume.

8. The reactor of claim 6, wherein said catalyst includes at least one photocatalyst.

9. The reactor of claim 6, wherein said catalyst includes at least one platinum catalyst.

10. A reactor, comprising:
at least a first electrode disposed in a liquid volume;
at least a second electrode disposed in a gaseous volume, said gaseous volume having an interface with said liquid volume; and
at least one power supply connected to said first and second electrodes for generating a high voltage electrical discharges between said first and second electrodes, wherein a zeolite comprising catalyst is included in at least one of said liquid volume and said gaseous volume.

11. The reactor of claim 10, wherein at least one of said electrical discharge comprises pulsed electrical discharges.

12. The reactor of claim 10, wherein chemically reactive liquid phase species generated by said reactor comprise at least one of hydrogen peroxide, hydrogen, and hydroxyl radicals.

13. The reactor of claim 10, wherein chemically reactive gas phase species generated by said reactor comprise at least one of ozone, oxygen radicals, hydroxyl radicals, and gaseous ions.

14. The reactor of claim 10, wherein said liquid volume or gaseous volume includes a non-zeolite catalyst.

15. The catalysts of claim 14, wherein said non-zeolite catalyst includes at least one photocatalyst.

16. A method for the destruction of contaminants, comprising the steps of:
generating a first high voltage electrical discharge across at least a portion of a gaseous volume for the generation of at least one chemically reactive gaseous species;
generating a second high voltage electrical discharge across at least a portion of a liquid volume for the generation of at least one chemically reactive liquid phase species, said gaseous volume having an interface with said liquid volume, wherein contaminants in said gaseous volume or said liquid volume are degraded by action of at least one of said chemically reactive gaseous species and said chemically reactive liquid species.

17. The method of claim 16, wherein at least one of said high voltage electrical discharge comprises pulsed electrical discharges.

18. The method of claim 16, wherein said chemically reactive liquid phase species generated by said reactor comprise at least one of hydrogen peroxide, hydrogen, and hydroxyl radicals.

19. The method of claim 16, wherein said chemically reactive gas phase species generated by said reactor comprise at least one of ozone, oxygen radicals, hydroxyl radicals, and gaseous ions.

20. The method of claim 16, wherein said liquid or gaseous volume includes at least one catalyst.

21. The method of claim 20, wherein said catalyst includes at least one zeolite.

22. The method of claim 20, wherein said catalyst includes at least one photocatalyst.

23. The method of claim 20, wherein said catalyst includes at least one platinum comprising catalyst.
